(19) United States
(12) Patent Application Publication
(10) Pub. No.: US 2003/0230119 A1
(43) Pub. Date: Dec. 18, 2003

(54) Unitary wrought spinner

(75) Inventors: Patrick S. Coffey, Lebanon, OR (US); Gary W. Warnock, Lebanon, OR (US); Jacob G. Crandall, Albany, OR (US)

Correspondence Address: KOLISCH HARTWELL, P.C., 520 S.W. YAMHILL STREET, SUITE 200, PORTLAND, OR, 97204, US

(73) Assignee: Metal Technology, Inc.

(21) Appl. No.: 10/174,773

(22) Filed: Jun. 18, 2002

(51) Int. Cl. C03B 37/04

(52) U.S. Cl. 65/521

(57) ABSTRACT

A process for manufacturing a spinner for rotary fiberization is provided. The method may include providing a blank of a high temperature metal, deep drawing the blank using a punch and a die to form a cup structure, installing a multi-component mandrel assembly in the cup structure, cold working the cup structure to form an inwardly-directed annular lip, disassembling the mandrel assembly, and removing the individual mandrel components.

### FIELD OF THE INVENTION

The invention relates to methods of cold working metals. More specifically, the invention relates to the manufacture of spinners useful for rotary fiberization processes from high temperature metals.

### BACKGROUND OF THE INVENTION

During rotary fiberization, a stream of molten thermoplastic material is extruded into a spinner that rotates at very high speeds. Centrifugal force forces the molten material against the peripheral side wall of the spinner, and through multiple small holes in the wall, forming small diameter molten strands. The extruded strands may be cooled and/or directed by air streams to a collection surface. The thermoplastic material may be an organic or inorganic material, including polymers, or natural or synthetic glasses. Rotary fiberization is used to manufacture a variety of microfibers that are used in a variety of applications.

Spinners are operated at elevated temperatures (˜2,000° F.), under high mechanical stress due to high rotational speeds (for example in the range of approximately 2,000 rpm to 4,000 rpm), often in an extremely corrosive environment, particularly where the thermoplastic material is a molten glass. Spinners are therefore typically formed from materials having high rupture strength and high oxidation resistance at elevated temperatures. However, the punishing conditions encountered during use results in the eventual failure of even such highly robust materials.

Rotary fiberization spinners are typically manufactured either by casting, or by ring-rolling or hydroforming at high temperatures. Cast spinners are typically cast in crude form and then machined to a required final form. The machining process typically generates a great deal of waste material, and in the case of many high temperature metal alloys, such waste can be highly expensive. Additionally, the machining process has been less than perfectly effective at producing ‘balanced’ spinners, capable of smooth rotation at high speeds. Cast spinners may also fail catastrophically, if not explosively, generating a spray of hot metal fragments. Fiberization processes that utilize cast spinners may therefore require additional safety equipment (and therefore additional expense) to shield the spinners during operation.

Alternatively, while rolled spinners may tend to fail somewhat more gracefully, such spinners also tend to ‘creep’ throughout their useful life, exhibiting continuous dimensional changes until failure. The manufacturing process for rolled spinners also generates significant and expensive metal waste, and requires that the spinner be formed at highly elevated temperatures, at least above the recrystallization temperature for the metal or metal alloy (as described in U.S. Pat. No. 5,085,679, hereby incorporated by reference). The specialized manufacturing equipment, as well as the equipment needed to maintain the extreme temperatures required, all contribute to high manufacturing costs and manufacturing complexity for rolled spinners.

Rotary fiberization spinners may be formed by separately shaping an upper section and lower section of the spinner, then welding or brazing the two sections together (as described in U.S. Pat. No. 5,118,332 to Hinze, hereby incorporated by reference). However, the heat-treatment due to the welding process typically results in a hardened area on or near the side wall of the spinner, making it more difficult to form the requisite fiber-forming apertures. Additionally, even when the weld bead is mechanically smoothed (again generating extra cost) the bead may still present surface roughness sufficient to compromise the smooth flow of molten material up the sides of the spinner during fiberization, or to capture the fiberized material on the outside of the spinner.

### SUMMARY OF THE INVENTION

The present invention provides a process for manufacturing a spinner for rotary fiberization. The method may include providing a blank of a high temperature metal, deep drawing the blank using a punch and a die to form a cup structure, installing a multiple component mandrel assembly in the cup structure, cold working the cup structure to form an inwardly-directed annular lip, disassembling the mandrel assembly, and removing the individual mandrel components.

### BRIEF DESCRIPTION OF THE DRAWINGS

FIG. 1 is a perspective view of a rotary fiberization spinner according to an embodiment of the present invention.

FIG. 2 is a cross-sectional perspective view of the rotary fiberization spinner of FIG. 1.

FIG. 3 is a flowchart of a method of manufacturing a rotary fiberization spinner, according to a selected method of the invention.

FIG. 4 shows a metal blank before and after a deep-drawing process that forms the blank into a cup structure.

FIG. 5 is an exploded cross-sectional perspective view of the cup structure of FIG. 4 in combination with selected tooling for forming an inwardly-directed annular lip on the cup structure, according to a selected method of the invention.

FIG. 6 is a cross-sectional view of the cup structure and tooling of FIG. 5.

FIG. 7 is a cross-sectional view of an intermediate spinner in combination with selected tooling for forming the intermediate spinner, according to a selected method of the invention.

FIG. 8 is a cross-sectional view of a spinner body in combination with selected tooling for forming the spinner body, according to a selected method of the invention.

### DETAILED DESCRIPTION OF THE PREFERRED EMBODIMENTS

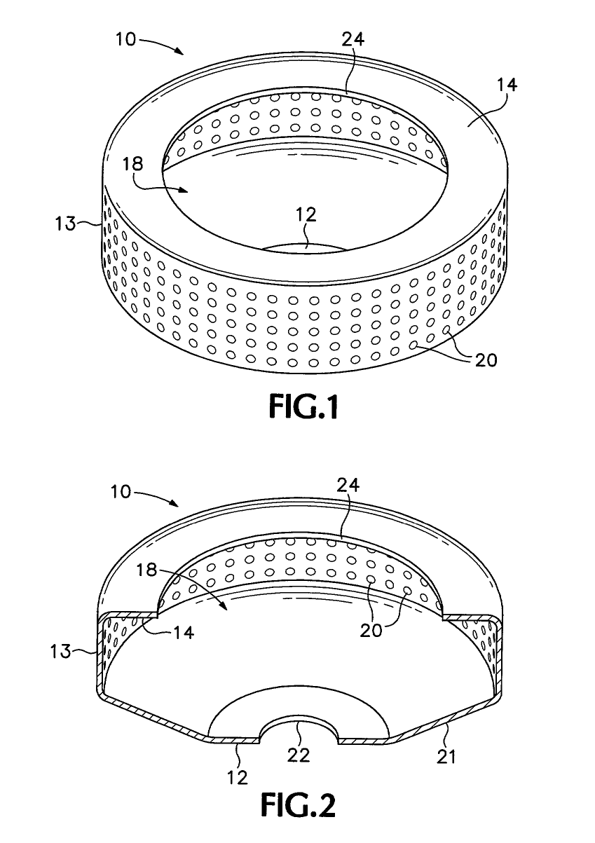

Referring to the drawings, FIG. 1 illustrates a rotary fiberization spinner 10 suitable for the manufacture of fibers from a molten thermoplastic material by a rotary process. Spinner 10 includes a bottom wall 12, a peripheral side wall 13, and an annular lip 14. The bottom wall, side wall, and lip define a cavity 18. The side wall includes a plurality of individual apertures 20 for forming fibers of thermoplastic material during fiberization. The size and density of the apertures 20 depends on the size and number of the fibers to be formed with the spinner. The aperture sizes depicted in FIGS. 1 and 2 are exaggerated for the purposes of illustration.

FIG. 2 shows spinner 10 in a cross section taken along its center of symmetry. As shown, bottom wall 12 may include a sloped portion 21 adjacent the lower periphery of the side wall, as well as a central hole 22 in the bottom wall for attaching the spinner to a fiberization apparatus. Side wall 13 may be substantially cylindrical, or substantially frustoconical. Annular lip 14 typically defines a central opening 24 that provides access to cavity 18. The particular dimensions of spinner 10 may be selected depending on the volume of thermoplastic material passing through the spinner during use, and the structure of the fiber to be manufactured using the spinner. For example the height of side wall 13, the diameter of apertures 20, and the overall diameter of the spinner may be selected for a particular application. Although central hole 22 is described as useful for attaching the spinner, for example to the spindle of a fiberization apparatus, any other suitable alternative structural feature that facilitates attachment to a fiberization apparatus is a suitable structural feature for the purposes of the invention. For example, a suitable alternative structure feature may include a pattern of apertures, such as a circular pattern of apertures, where each aperture is configured to receive a bolt, screw, or other fastener.

During a typical rotary fiberization process, the spinner may be attached to a spindle via hole 22, and spun at a high rate of speed at an elevated temperature. A molten thermoplastic material may be extruded into cavity 18 via opening 24, such that centrifugal acceleration forces the thermoplastic material up the sloped section of the bottom wall to the side wall, and out of the fiber-forming apertures, where the individual strands are cooled to form individual fibers.

The spinner of FIGS. 1 and 2 is a cold-formed unitary body. As used herein, ‘cold-formed’ refers to metal that has been shaped at temperatures below the recrystallization temperature of the metal used. Metal shaped at low temperatures may also be known as ‘cold worked’. As used herein, a ‘unitary’ body is formed from a single piece of metal, and has no welds or seams.

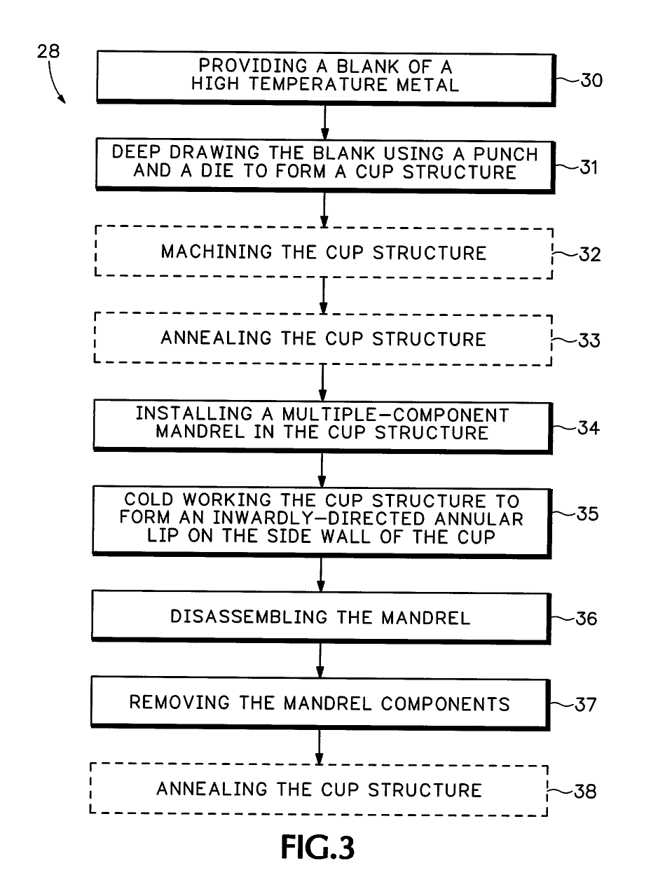

A method of manufacturing spinners, according to a particular aspect of the present invention, is shown in FIG. 3 as a flowchart 28. The method includes providing a blank of a suitable high temperature metal, as shown at 30. The size of the blank provided is related to the desired size of the finished spinner. Any blank that yields a satisfactory spinner after the subsequent shaping processes as described below is a blank having a suitable size and shape for the present invention. However, waste of the high temperature metal may be minimized by providing a disk-shaped blank.

As described above, the rotary fiberization process involves both significant mechanical stresses as well as exposure to high temperatures and corrosive conditions. Therefore the blank is typically composed of a high temperature and/or refractory metal that is strong, capable of enduring high temperatures, and exhibits corrosion resistance. The high temperature metal may include a metal alloy. By ‘high temperature metal’ is meant a metal or metal alloy that resists degradation and/or corrosion at elevated temperatures, for examples, at temperatures above 1,000° F. A preferred high temperature metal resists degradation and/or corrosion at temperatures above 2,000° F. Several commercial sources for suitable corrosion resistant and heat resistant metal alloy blanks exist, such as Rolled Alloys, Inc. (Temperance, Mich.), Haynes International, Inc. (Kokomo, Ind.), and Special Metals Corporation (Huntington, W. Va.). The metal blank typically includes an alloy that possesses high-temperature strength and oxidation resistance while still permitting cold working techniques. The high temperature metal alloy may include one or more of cobalt, nickel, chromium, tungsten, niobium, tantalum, aluminum, iron, titanium, molybdenum, manganese, or other metals, in order to confer corrosion resistance and strength to the resulting spinner. In particular nickel and/or cobalt containing alloys, such as cobalt-nickel-chromium-tungsten alloys, or nickel-chromium-aluminum-iron alloys, may be particularly suitable high temperature alloys. The particular metal or metal alloy best suited for a particular spinner application is dependent upon the particular thermoplastic material used, the desired operating temperature, and the mechanical stresses likely to be experienced by the spinner, among other operational parameters.

The high temperature metal blank may be shaped into a cup structure using a deep drawing process, as shown at 31 of FIG. 3. Deep drawing, as used herein, is a cold forming process in which a flat blank of sheet metal is shaped by the action of a punch forcing the metal into a die cavity. Deep drawing involves substantial plastic deformation of the metal, and generally produces a cup-shaped structure.

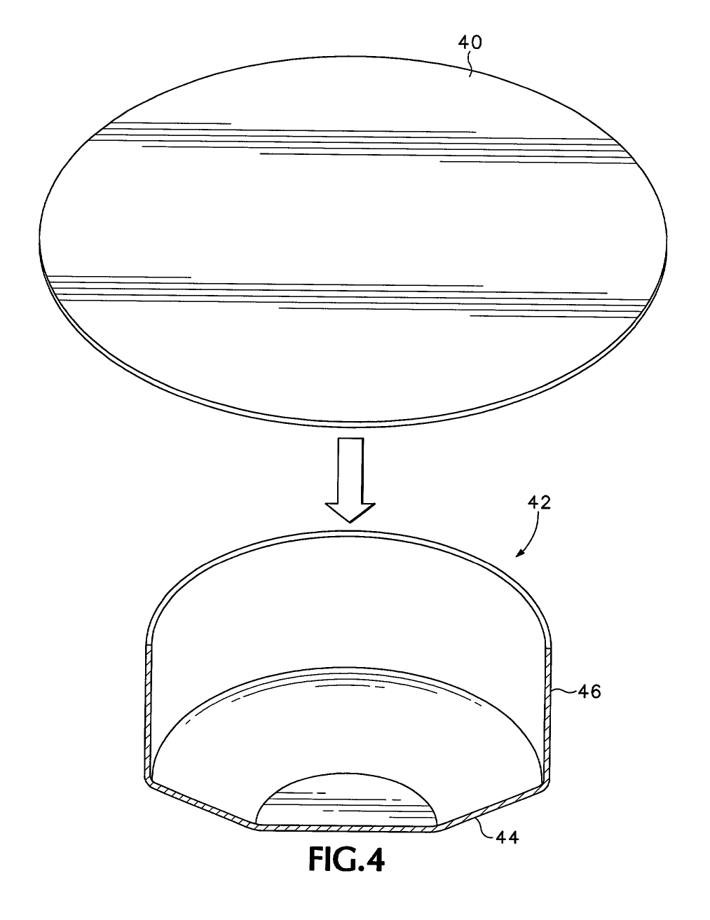

As shown in FIG. 4, disk shaped blank 40 may be deep drawn into a cup structure 42. Cup structure 42 is defined by a bottom wall 44 and a peripheral side wall 46. The deep drawing process may utilize a boundary lubricant, to prevent direct metal-to-metal contact under the conditions of high pressure and temperature typically produced during the deep drawing operation. The lubricant may also facilitate removal of the cup structure from the die. A useful lubricant may be a liquid, a solid, or an emulsion. Once the cup structure has been formed, it may be machined before it is further shaped, as shown at 32 of FIG. 3. Such machining may be useful to form a side wall having a determined height, for example, or to otherwise facilitate one or more aspects of the manufacturing process.

After the cup structure is formed, it is optionally annealed, as shown at 33 of FIG. 3, in order to relieve stresses in the metal induced by the deep drawing process. Annealing, as used herein, refers to a process of heating and cooling in order to remove stresses, alter ductility or toughness, or change other physical properties. Where the cup structure is formed from a metal alloy, the cup structure may be solution annealed after deep drawing. ‘Solution annealing’ refers to a process in which an alloy is heated to a suitable temperature, and is held at this temperature long enough to allow one or more constituents of the alloy to enter into a solid solution. The alloy is then cooled rapidly so as to hold the constituent in solution. Typically, the cup structure is annealed at a temperature in the range of approximately 2,150° F. to 2,175° F. for a time of approximately 30 minutes, followed by rapid air cooling. A piece may be annealed one or more times, but still be considered to be cold-formed, provided that each metal shaping step of the manufacturing process occurs at a temperature below the recrystallization temperature of the metal used.

After annealing, when performed, the deep-drawn cup structure may be inserted into, or assembled with, tooling appropriate for further cold working, particularly tooling suitable for use in conjunction with a press. Such tooling may be configured so as to fold an upper portion of the side wall of cup structure 42 inward, in order to create the annular lip necessary to form a spinner body. Such tooling may include, without limitation, base plates, sleeves, mandrels, and form tooling. In particular, the cup structure may be cold-worked in conjunction with a multiple-component mandrel that is installed in the cup structure prior to further shaping, as shown at 34 of FIG. 3.

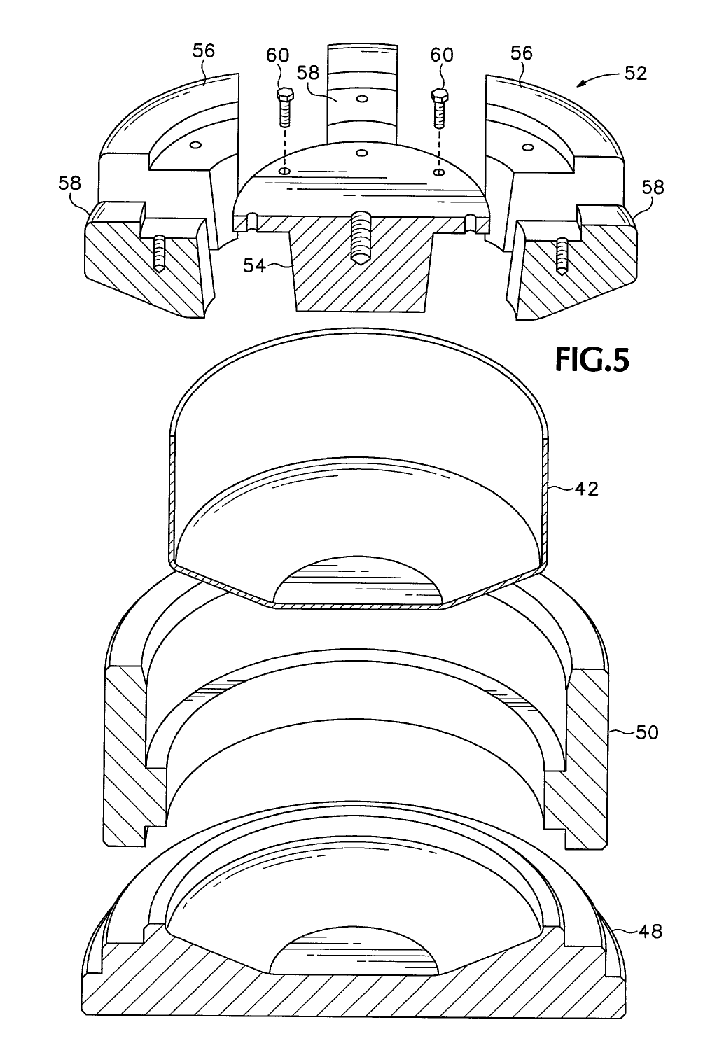

As shown in FIG. 5, cup structure 42 is placed in tooling configured to facilitate the formation of a spinner body by forming an annular lip on the side wall. Cup structure 42 rests on a base plate 48, and is surrounded by a sleeve 50. A multi-component mandrel 52 is installed inside cup structure 42. The multiple-component mandrel may be configured to provide internal support for the cup structure as it is being formed on a press, as well as to facilitate removal of the mandrel after the cold pressing process is complete. It will be apparent to one of skill in the art that a solid mandrel appropriately sized to provide the necessary internal support during pressing may not subsequently be removable through the resulting narrowed opening defined by the annular lip. Therefore, the mandrel is configured so that it may be disassembled and the individual mandrel components removed through the spinner opening in sequence.

A variety of possible configurations may be envisioned for the multiple-component mandrel, each facilitating the necessary disassembly and removal after the spinner body is formed. The particular multiple-component mandrel shown in FIGS. 5 and 6 includes a central taper plug 54 and eight components of an encircling ring, including four wedge-shaped ring components 56 and four parallel-faced ring components 58. Each ring component may be secured to the taper plug using one or more appropriate fasteners 60, such as screws, bolts, pins, or other means of attachment. When fully assembled, the ring components, taken in combination, form a ring around the taper plug, with wedge-shaped components and parallel-faced components in alternating positions in the ring.

When the individual components of mandrel 52 are properly positioned, aligned, and interconnected, mandrel 52 provides the internal support for the workpiece required during the pressing process that curls the side wall inward. In addition, the secure fastening of each ring component to the taper plug prevents the taper plug from being pushed out of position during the curling process.

Installing the multiple-component mandrel 52 in cup structure 42 optionally includes assembling the mandrel before it is inserted into the cup structure, assembling the mandrel within the cup structure, or any possible combination of partial assembly outside and inside the cup structure. Similarly, cup structure 42 may be placed upon base plate 48 before or after mandrel 52 is installed, and sleeve 50 may be positioned before or after cup structure 42 is placed upon base plate 48.

Once the mandrel has been installed, the cup structure and mandrel may be placed upon base plate 48 and within sleeve 50, as shown in FIG. 6, and appropriate curl tooling may be applied to cup structure 42 using a press. The curl tooling optionally includes fittings and/or attachments so that it may be fastened to the ram of the press, permitting the tooling to be raised and lowered without direct manipulation by the press operator. The application of the curl tooling typically folds an upper portion of side wall 46 of cup structure 42 inward to form the annular lip, as shown at 35 of FIG. 3.

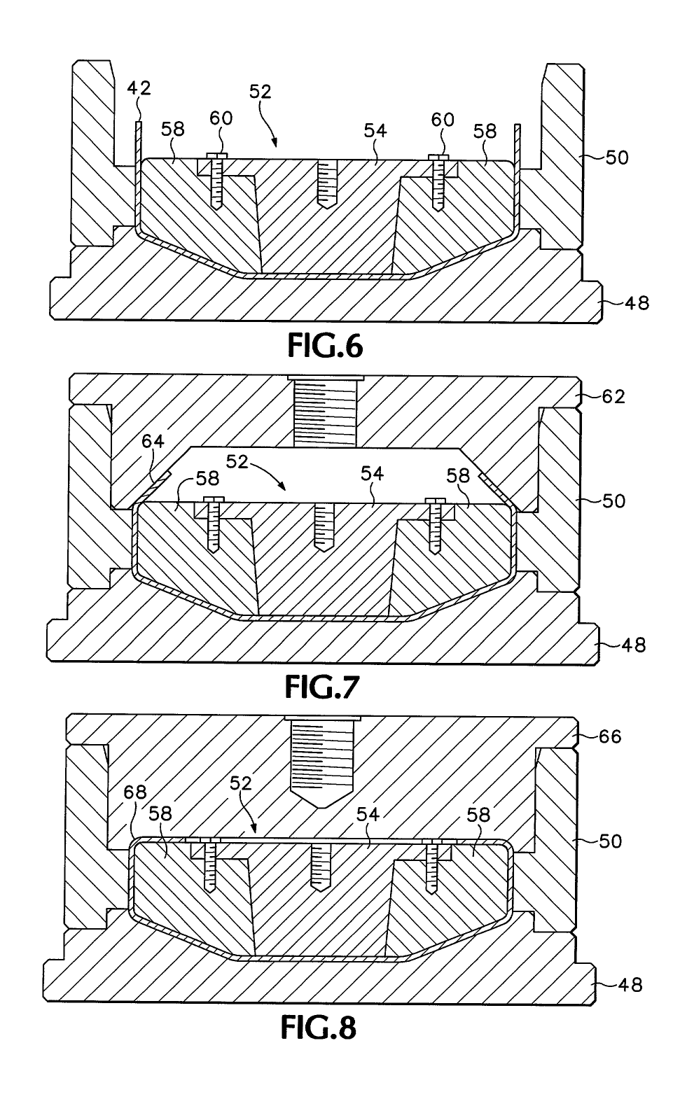

The annular lip may be formed in a single pressing step, or it may be formed in multiple pressing steps. Where the lip is formed in multiple pressing steps, multiple distinct pieces of curl tooling may be used, as shown in FIGS. 7 and 8.

In particular, as shown in FIG. 7, preform curl tooling 62 may be configured to fold the side wall of cup structure 42 inward to an intermediate angle upon application, thereby forming an intermediate spinner body 64. Preform curl tooling 62 may be configured to form any of a variety of intermediate angles, but is typically configured to create an intermediate angle close to 45° from vertical. Tooling 62 may be applied at a predetermined pressure, in order to insure that the tooling itself is not damaged at higher applied pressures. Formation of the annular lip may be performed for example on a 1000 ton press, using 300 tons of gauge pressure. The actual applied pressure may vary depending upon the particular press and high temperature metal used to manufacture the spinner.

As shown in FIG. 8, after formation of intermediate spinner body 64, the application of final form tooling 66 may substantially form the desired annular lip, thereby creating a spinner body 68. Typically, throughout the pressing operations, the temperature of the workpiece is kept below the recrystallization temperature for the high temperature metal used to form the spinner body.

Once the spinner body is formed, the mandrel may be disassembled, and the components may be removed from the spinner body, as shown at 36 and 37 of FIG. 3. The mandrel may be disassembled by first removing fasteners 60, and then removing taper plug 54 via the opening defined by the annular lip. Once the taper plug has been removed, one or more of the parallel-faced ring components 58 may be shifted inwardly and similarly removed via the opening in the spinner body. The remaining wedge-shaped ring components 56 may then be removed in the same way.

After has been formed, the spinner body may be annealed, as shown at 38 of FIG. 3, so as to relieve stresses resulting from the pressing operations, for example. However, such an annealing step is typically not required.

The spinner body may be machined to form the central hole in the bottom wall of the spinner. Alternatively, a central hole may be formed in the bottom wall 44 of cup structure 42 prior to cold working the cup structure in order to form the annular lip. Additional machining of the spinner, including shaping, smoothing, balancing, and/or polishing, may be performed either before or after the apertures in the side wall are formed.

The individual apertures in the side wall of the spinner body are typically manufactured according to methods known in the art. The size of the apertures, in part, regulates the diameter of the fibers formed using the spinner, and so the aperture-forming process may require significant precision. A particular spinner may have several thousand individual apertures formed in the peripheral side wall, depending upon the size of the fibers to be manufactured and the size of the particular spinner being manufactured. The apertures may be formed using various techniques, including laser drilling, electron beam drilling, electrical discharge machining, and twist drilling, among others. Typically, the apertures are formed using electrical discharge machining, including high-speed wire electrical discharge machining (EDM).

Spinners prepared according to a method of the invention may be of any size appropriate for a given rotary fiberization process, including without limitation spinners having an overall diameter of about eight inches, or smaller, to spinners having an overall diameter of about twenty-four inches, or larger.

The unitary construction of spinners manufactured according to the present methods results in enhanced performance during fiberization, as compared to spinners manufactured using previously described methods. In particular, unitary wrought spinners manufactured according to process of the invention may exhibit operational lifetimes that are double the lifetimes of spinners manufactured using previously described methods. The unitary spinners possess no seams or weld beads to compromise the flow of molten materials within the spinner cavity, and typically may be precisely balanced with respect to high speed rotation. In addition, the unitary wrought spinners described herein typically fail gracefully, rather than explosively, as has been observed for some cast spinners. Significantly, the methods of the invention are typically highly conservative of the metal used, require either no or very little machining after the spinner is formed, and therefore typically generate very little waste, each factor thereby contributing to reduced manufacturing costs. The cold-working methods described herein may be used to create spinners that perform advantageously, while requiring lower manufacturing costs, than previous methods of spinner manufacture.

Although the present invention has been shown and described with reference to the foregoing operational principles and preferred embodiments, it will be apparent to those skilled in the art that various changes in form and detail may be made without departing from the spirit and scope of the invention. The present invention is intended to embrace all such alternatives, modifications and variances that fall within the scope of the appended claims.

What is claimed is:

1. A process for manufacturing a spinner for rotary fiberization, comprising:
providing a blank of a high temperature metal;
deep drawing the blank to form a cup structure having a bottom wall and a peripheral side wall;
installing a mandrel assembly in the cup structure, where the mandrel includes a plurality of individual components;
cold working the cup structure to form an inwardly-directed annular lip on the side wall;
disassembling the mandrel assembly into the individual components; and
removing the individual components of the mandrel.

2. The method of claim 1, further comprising forming a plurality of fiber-forming apertures in the side wall.

3. The method of claim 2, where the fiber-forming apertures are formed using electrical discharge machining.

4. The method of claim 1, where the side wall is substantially cylindrical.

5. The method of claim 1, where the side wall is substantially frustoconical.

6. The method of claim 1, where cold working the cup structure includes multiple pressing operations.

7. The method of claim 1, where cold working the cup structure includes:
a first pressing operation that forms the inwardly-directed annular lip at an intermediate angle to the side wall; and
a second pressing operation that brings the inwardly-directed annular lip to a final angle to the side wall.

8. The method of claim 7, where the first pressing operation and the second pressing operation employ a first tooling and a second tooling, respectively.

9. The method of claim 1, further comprising annealing the cup structure.

10. The method of claim 1, further comprising forming a central aperture in the bottom wall.

11. The method of claim 10, where the axial aperture is formed after the mandrel is removed.

12. The method of claim 1, further comprising machining the peripheral side wall to a determined height.

13. The method of claim 1, where the blank is a high temperature metal disk.

14. The method of claim 1, where the high temperature metal is a high temperature metal alloy.

15. The method of claim 14, where the cup structure is formed by deep drawing at a temperature below the recrystallization temperature of the high temperature metal alloy.

16. The method of claim 14, where the annular lip is formed at a temperature below the recrystallization temperature of the high temperature metal alloy.

17. A process for cold forming a spinner for rotary fiberization from a single piece of metal, comprising shaping the metal at temperatures below the recrystallization temperature of the metal.

18. The process of claim 17, where shaping the piece of metal includes deep drawing and pressing the metal.

19. The process of claim 17, where the spinner has a bottom wall, a peripheral side wall, and an inwardly-directed annular lip on the side wall.

20. A structure for forming fibers from a thermoplastic material, comprising:
a cold formed unitary spinner having a bottom wall, a side wall peripheral to the bottom wall, an annular lip along an edge of the side wall, and a plurality of apertures in the side wall.

21. The structure of claim 20, where the bottom wall includes a sloped portion adjacent to the side wall.

22. The structure of claim 20, where the bottom wall includes a central hole.

23. The structure of claim 20, where the apertures are formed using electrical discharge machining.

24. The structure of claim 20, where the high temperature metal is a high temperature metal alloy.

25. A spinner body assembly, comprising
a spinner body having a bottom wall, a side wall peripheral to the bottom wall, and an annular lip along an edge of the side wall; and
a mandrel at least partially enclosed by the spinner body, where the mandrel includes a plurality of individual components.

26. The spinner body assembly of claim 25, where the mandrel includes a central taper plug and a plurality of ring components disposed around the central taper plug.

27. The spinner body assembly of claim 25, where the mandrel is retained within the spinner body until it is disassembled.
